(19) United States
(12) Patent Application Publication
(10) Pub. No.: US 2019/0118823 A1
(43) Pub. Date: Apr. 25, 2019

(54) ROAD SURFACE DETECTION APPARATUS, ROAD SURFACE DETECTION METHOD, AND RECORDING MEDIUM INCLUDING ROAD SURFACE DETECTION PROGRAM RECORDED THEREIN

(71) Applicant: PANASONIC INTELLECTUAL PROPERTY MANAGEMENT CO., LTD., Osaka (JP)

(72) Inventors: Tetsuro OKUYAMA, Osaka (JP); Hiroshi IWAI, Osaka (JP); Osamu SHIBATA, Hyogo (JP); Takehiro TANAKA, Osaka (JP)

(73) Assignee: PANASONIC INTELLECTUAL PROPERTY MANAGEMENT CO., LTD., Osaka (JP)

(21) Appl. No.: 16/169,002

(22) Filed: Oct. 24, 2018

(30) Foreign Application Priority Data
Oct. 25, 2017 (JP) 2017-206031

(51) Int. Cl. B60W 40/076; G06T 7/50

(52) U.S. Cl. CPC B60W 40/076; G06T 2207/30252; B60W 2420/42; G06T 7/50

(57) ABSTRACT

There is provided a road surface detection apparatus which can precisely estimate a road surface grade. The road surface detection apparatus includes: an inputter that receives an input of an image signal from an imaging apparatus; a distance measurer that divides a road surface into a plurality of cells based on the image signal, and derives a distance to a representative point of each of the cells by a time of flight distance measurement method; and an estimator that estimates a gradient of the road surface based on the distances to a plurality of representative points.

### TECHNICAL FIELD

The present disclosure relates to a road surface detection apparatus, a road surface detection method, and a recording medium including a road surface detection program recorded therein.

### BACKGROUND ART

Conventionally, there is a known road surface grade estimation apparatus which estimates, by using two cameras, a grade of a road surface on which a vehicle drives.

### CITATION LIST

### Patent Literature

PTL 1
JP 2009-139323 A

### SUMMARY OF INVENTION

### Technical Problem

Furthermore, a distance measurement method which uses a time of flight distance measurement method (referred to as a “time of flight (TOF) method” below) is known. By measuring a distance to a road surface, a road surface grade can be estimated. To precisely estimate the road surface grade, it is important to precisely estimate the distance to the road surface.

An object of the present disclosure is to precisely estimate a road surface grade.

### Solution to Problem

One embodiment of the present disclosure is a road surface detection apparatus that includes: an inputter that receives an input of an image signal from an imaging apparatus; a distance measurer that divides a road surface region into a plurality of cells based on the image signal, and derives a distance to a representative point of each of the cells by a time of flight distance measurement method; and an estimator that estimates a gradient of the road surface based on the distances to a plurality of the representative points. In addition, one embodiment of the present disclosure may be any one of a method and a non-transitory tangible recording medium including a program recorded therein.

### Advantageous Effects of Invention

According to the present disclosure, it is possible to precisely estimate a road surface grade.

### BRIEF DESCRIPTION OF DRAWINGS

FIG. 1 is a schematic view showing a vertical field of view of a surrounding monitoring system on which a road surface detection apparatus according to one embodiment of the present disclosure is mounted;

FIG. 2 is a schematic view showing a horizontal field of view of the surrounding monitoring system on which the road surface detection apparatus according to one embodiment of the present disclosure is mounted;

FIG. 3 is a block diagram showing a configuration of the surrounding monitoring system on which the road surface detection apparatus according to one embodiment of the present disclosure is mounted;

FIG. 4 is a schematic view showing an outline of a time of flight distance measurement method;

FIG. 5 is a flowchart showing an example of road surface grade estimation processing;

FIG. 6 is a flowchart showing an example of distance measurement processing;

FIG. 7 is a schematic view showing a state of emission light and return light;

FIG. 8 is a flowchart showing another example of distance measurement processing;

FIG. 9A is a schematic view showing a road surface on a vehicle rear side captured by an imaging apparatus;

FIG. 9B is a schematic view showing a state where the road surface is divided into a plurality of cells;

FIG. 9C is a schematic view showing a state where the road surface is divided into a plurality of cells seen from right above;

FIG. 9D is a schematic view showing representative points of cells;

FIG. 9E is a schematic view showing a state where the representative points of the cells are seen from right above;

FIG. 10 is a schematic view showing the height of the representative point from a reference road surface;

FIG. 11A is a schematic view showing cell division according to modified example 1;

FIG. 11B is a schematic view showing the cell division according to modified example 1 seen from right above;

FIG. 11C is a schematic view showing an error distribution with respect to an actual distance;

FIG. 11D is a schematic view showing an average value and standard deviations +σ and −σ of Depth values;

FIG. 12A is a schematic view showing a modified example of an installation place of an imaging apparatus;

FIG. 12B is a schematic view showing a modified example of the installation place of the imaging apparatus; and

FIG. 12C is a schematic view showing a modified example of the installation place of the imaging apparatus.

### DESCRIPTION OF EMBODIMENTS

Surrounding monitoring system 1 on which road surface detection apparatus 100 according to one embodiment of the present disclosure is mounted will be described in detail below with reference to the drawings. In this regard, the embodiment described below is an example, and the present disclosure is not limited by this embodiment.

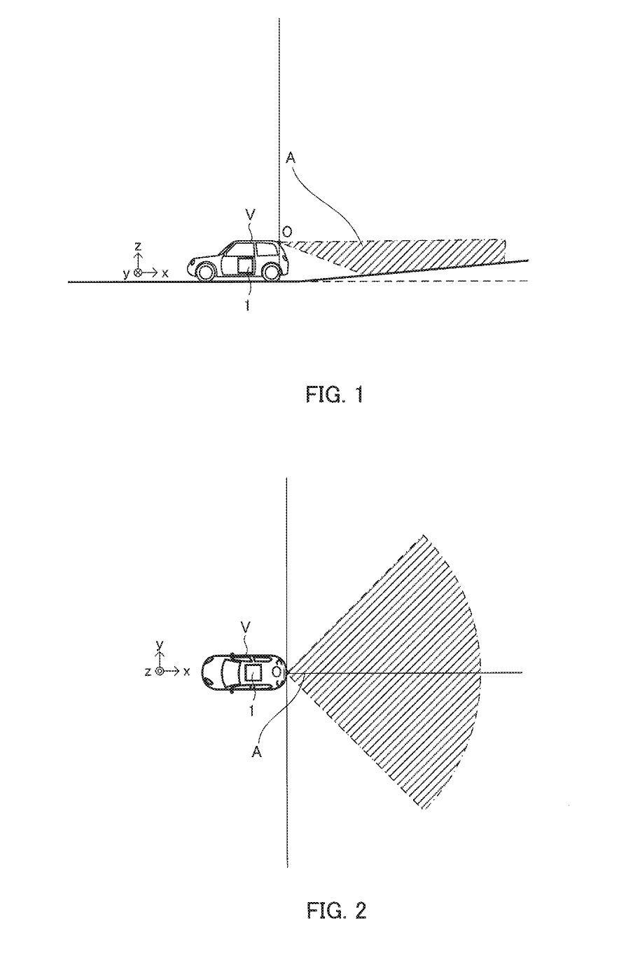

FIGS. 1 and 2 show an x axis, a y axis and a z axis perpendicular to each other. In the present disclosure, a positive direction of the x axis indicates a direction traveling from a front portion to a rear portion of vehicle V. A positive direction of the y axis indicates a direction traveling from a left side to a right side of vehicle V. A positive direction of the z axis indicates a direction traveling from a lower portion to an upper portion of vehicle V. Furthermore, according to the present disclosure, for ease of convenience, an xy plane is a flat road surface (referred to as a “reference road surface” below), and a zx plane is a vertical center plane of vehicle V. Furthermore, the x axis is a vertical center line of vehicle V in a plan view from a z axis direction.

As shown in FIGS. 1 and 2, surrounding monitoring system 1 is mounted on vehicle V. Hereinafter, it is described that surrounding monitoring system 1 monitors a rear side of vehicle V. However, surrounding monitoring system 1 may monitor sides (lateral sides, a front side or all surrounding directions) other than the rear side of vehicle V.

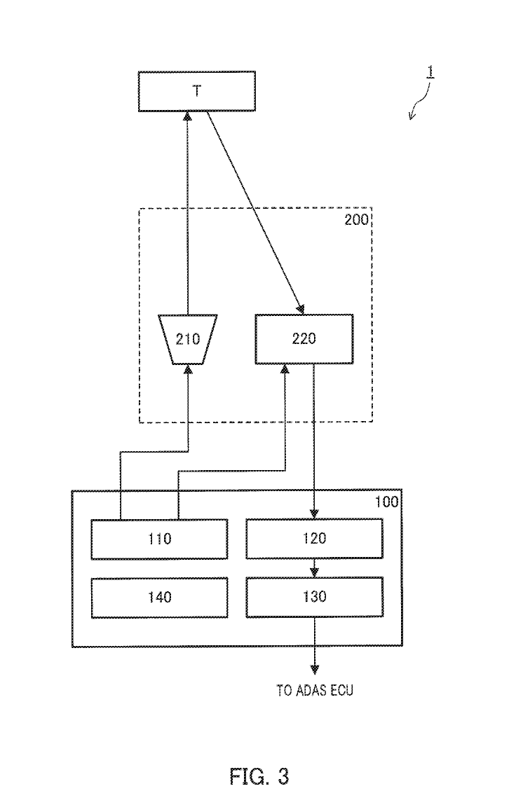

As shown in FIG. 3, surrounding monitoring system 1 includes imaging apparatus 200 which is formed by integrating light source 210 and image sensor 220, and road surface detection apparatus 100.

As shown in FIG. 1, imaging apparatus 200 is attached on a back surface of vehicle V and to place O apart from a road surface.

Light source 210 is attached so as to be able to emit invisible light having a cycle such as a pulse or a sine wave (e.g., infrared light or near infrared light) to an imaging range.

Image sensor 220 is, for example, a complementary metal oxide semiconductor (CMOS) image sensor, and is attached to the substantially same place as light source 210 such that optical axis A extends to the substantially rear side of vehicle V.

Road surface detection apparatus 100 is, for example, an electronic control unit (ECU), and includes an input terminal, an output terminal, a processor, a program memory and a main memory mounted on a control substrate to control monitoring of the rear side of vehicle V.

The processor executes programs stored in the program memory by using the main memory to process various signals received via an input terminal, and output various control signals to light source 210 and image sensor 220 via the output terminal.

When the processor executes the program, road surface detection apparatus 100 functions as imaging controller 110, distance measurer 120, road grade surface estimator 130 (an example of an “estimator”) and storage section 140 as shown in FIG. 3.

Imaging controller 110 outputs a control signal to light source 210 to control some conditions (more specifically, a pulse width, a pulse amplitude, a pulse interval and the number of pulses) of emission light from light source 210.

Furthermore, imaging controller 110 outputs a control signal to a peripheral circuit included in image sensor 220 to control some conditions (more specifically, an exposure time, an exposure timing and the number of times of exposure) of reception of return light of image sensor 220.

According to the above exposure control, image sensor 220 outputs an infrared image signal and a depth image signal related to the imaging range to road surface detection apparatus 100 at a predetermined cycle (predetermined frame rate). In addition, image sensor 220 may output a visible image signal.

Furthermore, in the present embodiment, image sensor 220 performs so-called lattice transformation of adding information of a plurality of neighboring pixels, and generating image information. In this regard, according to the present disclosure, it is not indispensable to add the information of a plurality of neighboring pixels and generate the image information.

Distance measurer 120 extracts a region of the road surface on the rear side from the image outputted from image sensor 220, and divides this region into a plurality of cells.

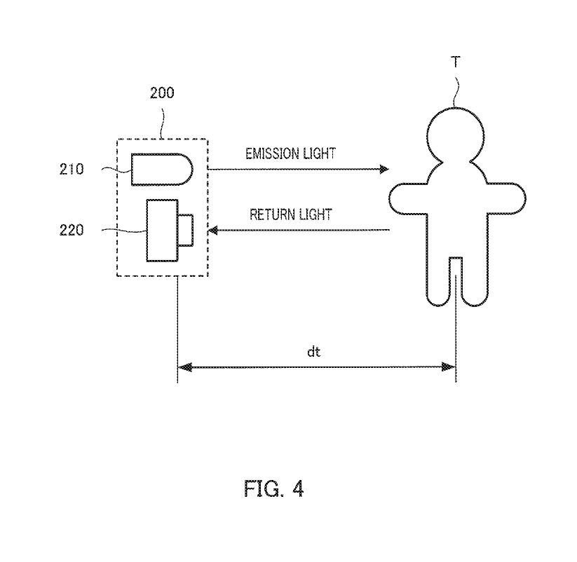

Furthermore, distance measurer 120 derives a distance (see FIG. 4) to a representative point of each cell by a TOF method based on the depth image signal outputted from image sensor 220. In addition, FIG. 4 is a schematic view showing states of emission light and return light when distance dt to target T is derived.

Road grade surface estimator 130 estimates a grade (an example of a “gradient”) of the road surface on the rear side based on distances to representative points of a plurality of cells derived by distance measurer 120. More specifically, road grade surface estimator 130 estimates a relative gradient with respect to a road surface on which the vehicle is currently located on the road surface on the rear side.

Storage section 140 stores various pieces of information used for distance measurement processing and road surface grade estimation processing.

Surrounding monitoring system 1 outputs a signal related to the grade of the road surface on the rear side. This information is transmitted to, for example, an advanced driver assistance system (ADAS) ECU. The ADAS ECU automatically drives vehicle V by using these pieces of information.

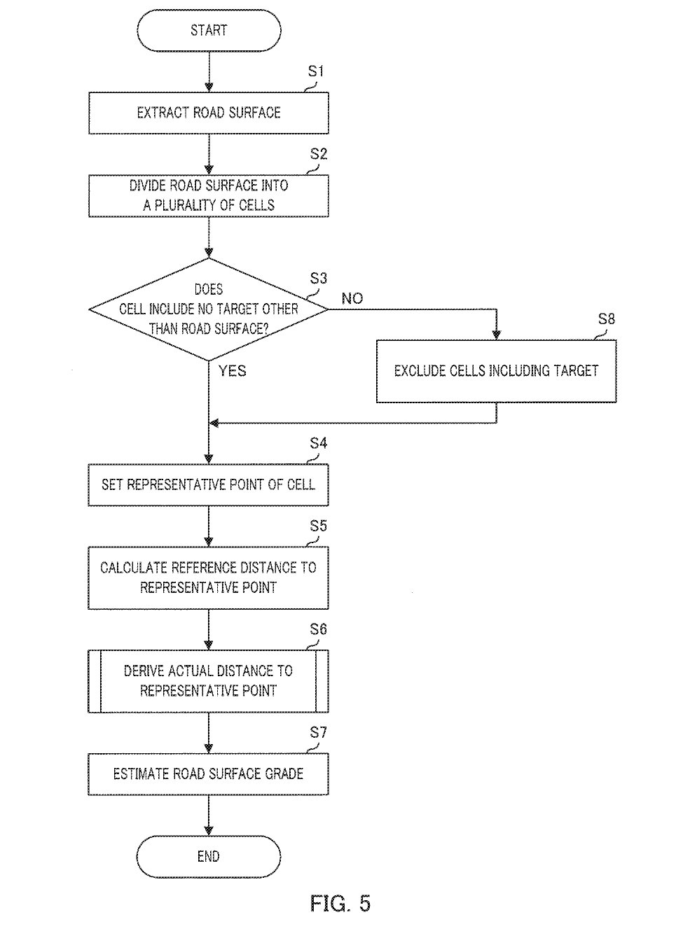

Next, road surface grade estimation processing performed by distance measurer 120 and road grade surface estimator 130 of road surface detection apparatus 100 will be described in detail with reference to the flowchart in FIG. 5.

First, in step S1, distance measurer 120 determines a range for estimating the road surface grade in the image received from image sensor 220. This range for estimating the road surface grade is determined based on attachment information such as an attachment position and orientation of imaging apparatus 200, and a field of view (FOV) of light source 210. Furthermore, distance measurer 120 may extract as the road surface a region sandwiched by portions (white lines) of a high brightness based on brightness information of the image signal received from image sensor 220, and determine this region as the range for estimating the road surface grade. Furthermore, this range for estimating the road surface grade may be determined by using all pieces of information including the attachment information of imaging apparatus 200, the FOV of light source 210, and the brightness information of the image received from image sensor 220. In addition, the road surface may be extracted by using a depth image and a visible image.

In subsequent step S2, distance measurer 120 divides the road surface extracted in step S1 into a plurality of cells. Into what shapes of cells the road surface is divided is set in advance according to processing contents performed in subsequent steps.

In subsequent step S3, distance measurer 120 decides for each cell divided in step S2 whether or not each cell includes a target other than the road surface. When, for example, each cell includes a predetermined rate or more of portions in which brightness is higher than a predetermined value, distance measurer 120 decides that each cell includes the target (e.g., wheel stopper) other than the road surface.

When it is decided in step S3 that one of the cells includes the target other than the road surface (step S3: NO), the processing moves to step S8. Furthermore, in step S8, a cell which is decided in step S3 to include the target other than the road surface is excluded from a processing target of subsequent processing, and the processing moves to step S4.

On the other hand, when it is decided in step S3 that any one of the cells does not include the target other than the road surface (step S3: YES), the processing moves to step S4.

In step S4, distance measurer 120 sets for each cell a predetermined pixel in each cell as a representative point of each cell. In this regard, the term “representative point” in the following description is used to indicate a predetermined pixel and indicate an actual point on the road surface corresponding to the predetermined pixel as well. Which pixel in each cell is set as a representative point is set in advance according to processing contents performed in subsequent steps.

In subsequent step S5, distance measurer 120 calculates a distance (referred to as a “reference distance” below) to each representative point in a case where the road surface is assumed to be flat (the road surface is assumed to be a reference road surface) based on information stored in advance in storage section 140.

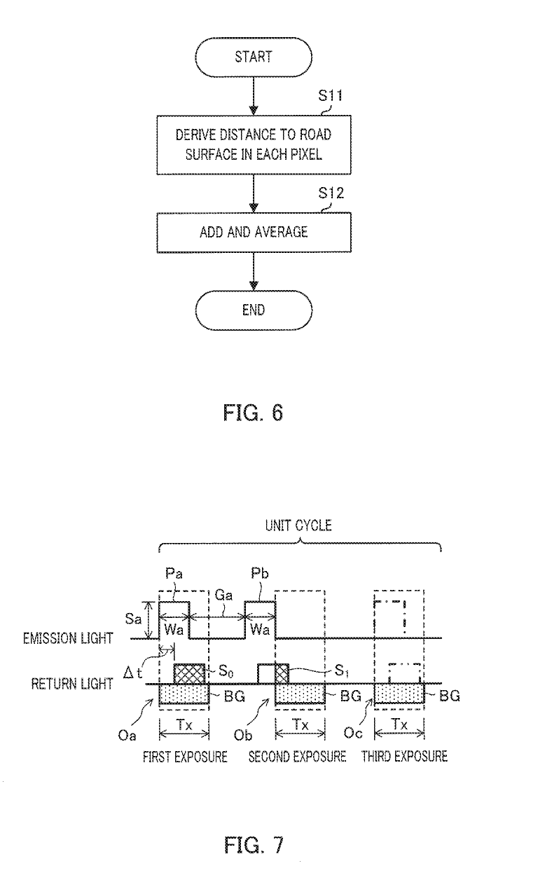

In subsequent step S6, distance measurer 120 derives a distance (referred to as an “actual distance” below) to the representative point of each cell by the TOF method. An example of processing (distance measurement processing) which is performed per cell in step S6 and derives an actual distance to a representative point will be described in detail with reference to a flowchart in FIG. 6.

First, in step S11, distance measurer 120 derives the distance to the road surface in each pixel in each cell by the TOF method.

Hereinafter, an example of distance measurement according to the TOF method will be described. As shown in FIG. 7, the emission light from light source 210 includes a pair of first pulse Pa and second pulse Pb in a unit cycle. A pulse interval between these pulses (i.e., a time from a rising edge of first pulse Pa to a rising edge of second pulse Pb) is Ga. Furthermore, pulse amplitudes of these pulses are equally Sa, and these pulse widths are equally Wa.

Image sensor 220 is controlled by imaging controller 110 to perform exposure at a timing based on emission timings of first pulse Pa and second pulse Pb. More specifically, as shown in FIG. 7, image sensor 220 performs first exposure, second exposure and third exposure on invisible light which is the emission light from light source 210 which has been reflected by target T in the imaging range and returned.

The first exposure starts at the same time as a rise of first pulse Pa, and ends after exposure time Tx set in advance in relation to the emission light from light source 210. This first exposure intends to receive return light components of first pulse Pa.

Output Oa of image sensor 220 resulting from the first exposure includes return light component S₀ to which an oblique lattice hatching is applied, and background component BG to which a dot hatching is applied. The amplitude of return light component S₀ is smaller than the amplitude of first pulse Pa.

A time difference between the rising edges of first pulse Pa and return light component S₀ is Δt. Δt represents a time taken by invisible light to travel back and forth over distance dt between imaging apparatus 200 and target T.

The second exposure starts at the same time as a fall of second pulse Pb, and ends after exposure time Tx. This second exposure intends to receive return light components of second pulse Pb.

Output Ob of image sensor 220 resulting from the second exposure includes partial return light component S₁ (refer to a diagonal lattice hatching portion) which is not the overall return light component, and background component BG to which a dot hatching is applied.

In addition, above component S₁ to be observed is generally given by following equation 1.

S₁=S₀×(Δt/Wa) (1)

The third exposure starts at a timing which does not include the return light component of first pulse Pa and second pulse Pb, and ends after exposure time Tx. This third exposure intends to receive only background component BG which is an invisible light component irrelevant to the return light component.

Output Oc of image sensor 220 resulting from the third exposure includes only background component BG to which a dot hatching is applied.

Distance dt from imaging apparatus 200 to the road surface can be derived based on the above relationship between the emission light and the return light according to following equations 2 to 4.

S₀=Oa−BG (2)

S₁=Ob−BG (3)

dt=c×(Δt/2)={(c×Wa)/2}×(Δt/Wa)={(c×Wa)/2}×(S₁/S₀) (4)

In this regard, c represents a light velocity.

In step S12 subsequent to step S11, distance measurer 120 adds and averages a distance to the road surface in each pixel in each cell derived in step S11, and outputs an averaging result as the distance to the representative point of each cell.

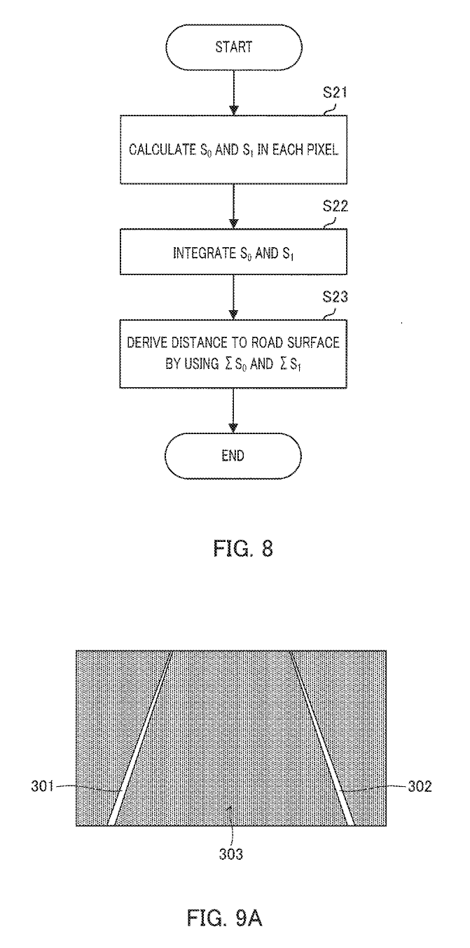

Another example of distance measurement processing performed per cell in step S6 will be described in detail with reference to a flowchart in FIG. 8. In the above example, the distance to the road surface of each pixel in each cell is derived and then is added and averaged, and the distance to the representative point of each cell is derived. By contrast with this, in an example described below, a return light component of each pixel in each cell is integrated, and the integrated return light component is used to derive a distance to a representative point of each cell.

In step S21, distance measurer 120 uses a depth image signal to calculate return light components S₀ and S₁ of each pixel in each cell by using above equations 2 and 3.

In subsequent step S22, distance measurer 120 integrates return light components S₀ and S₁ of each pixel in each cell, and obtains integration values ΣS₀ and ΣS₁ of the return light components.

In subsequent step S23, distance measurer 120 derives distance dt to the representative point of each cell by using following equation 5.

dt={c×Wa}/2}×(ΣS₁/ΣS₀) (5)

Back to description of FIG. 5, in step S7 subsequent to step S6, road grade surface estimator 130 estimates a road surface grade based on the reference distance to the representative point calculated in step S5 and the actual distance to the representative point derived in step S6.

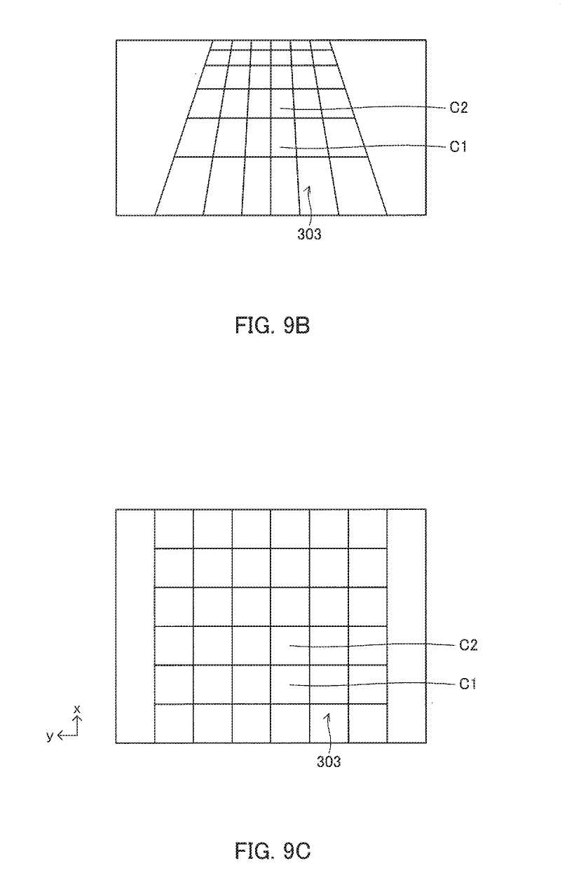

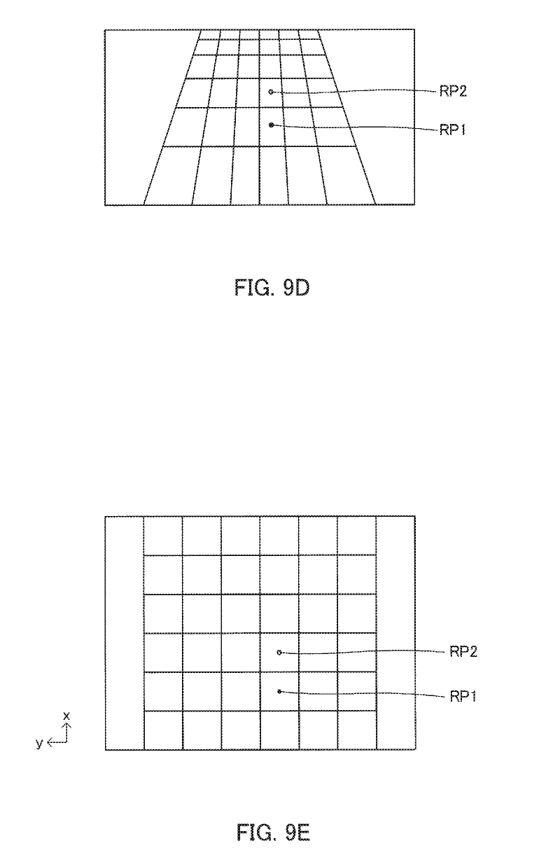

Next, a specific example of road surface grade estimation performed by road surface detection apparatus 100 according to the present embodiment will be described with reference to FIGS. 9A and 9E.

In a specific example described below, when subject vehicle V drives rearward in a situation there is an uphill on the rear side of subject vehicle V located on a flat road, the road surface grade in a traveling direction of subject vehicle V is estimated.

FIG. 9A shows an infrared image of an imaging range. In the infrared image, roadway edge markings 301 and 302 on the road surface are “regions of a high brightness”. Hence, distance measurer 120 extracts as road surface 303 a region sandwiched by roadway edge markings 301 and 302 in the infrared image shown in FIG. 9A.

After extracting road surface 303, distance measurer 120 divides road surface 303 into a plurality of cells. FIG. 9B shows road surface 303 divided into the cells. In this regard, in this example, cell division is performed as follows.

FIG. 9C is a view (zenith view)showing road surface 303 shown in FIG. 9B from right above. FIG. 9C shows the x axis and the y axis. Distance measurer 120 divides road surface 303 in FIG. 9B into cells such that cell shapes seen from right above are square shapes as shown in FIG. 9C.

Subsequently, in this example, there is no target on road surface 303, and therefore distance measurer 120 sets representative points to all divided cells. In addition, representative points may be set only to specific cells used for road surface grade estimation.

FIGS. 9D and 9E show, for example, representative point RP1 (black circle) set to a center of cell C1 which is the second cell from the front side and the third cell from the right, and representative point RP2 (white circle) set to a center of cell C2 which is the third cell from the front side and the third cell from the right among representative points RPi set to all cells Ci (i=1, 2, . . . and n (n: the number of times of divisions)).

Storage section 140 stores a coordinate (Xi, Yi, 0) as a look up table (LUT) in a case where height H at which imaging apparatus 200 is disposed and representative point RN disposed are on the reference road surface. Distance measurer 120 uses these items of data to calculate reference distance D_{RPi} from subject vehicle V (more specifically camera O) to representative point RPi. In addition, reference distance D_{RPi} to representative point RPi may be stored in advance in storage section 140.

Subsequently, distance measurer 120 uses the distance image to derive actual distance d_{RPi} from subject vehicle V to representative point RPi by the TOF method. In this case, in this example, as described above, information of each pixel in cell Ci is used to derive d_{RPi}.

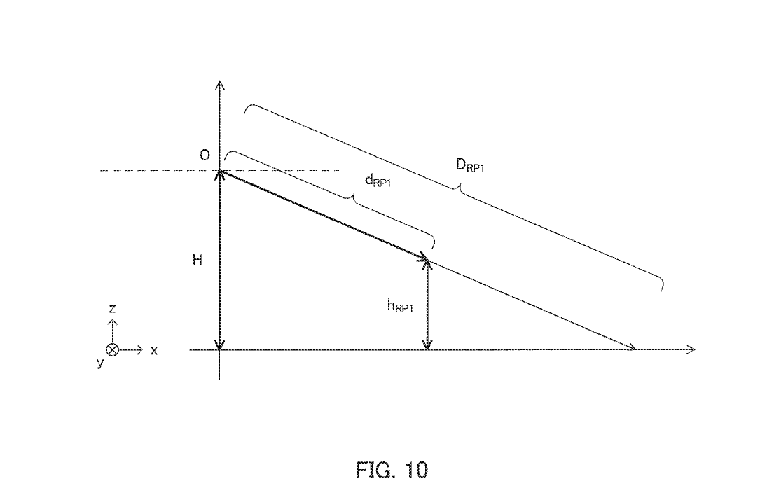

Road grade surface estimator 130 calculates height h_{RPi} from the reference road surface of each representative point RPi based on reference distance D_{RPi} and actual distance d_{RPi} from subject vehicle V to each representative point RPi in each cell Ci by using following equation 6. In addition, FIG. 10 schematically shows a relationship between reference distance D_{RPi}, actual distance d_{RPi}, height H and height h_{RPi}.

h_{RPi}=H×(D_{RPi}−d_{RPi})/D_{RPi} (6)

Furthermore, road grade surface estimator 130 estimates the grade of road surface 303 by using height h_{RPi} from the reference road surface of each representative point RPi. In this example, heights h_{RP1} and h_{RP2} of neighboring cell C1 and cell C2 in the traveling direction of subject vehicle V are used to calculate a gradient with respect to a straight reference plane which connects representative points RP1 and RP2. Furthermore, this gradient is regarded as the grade of road surface 303 in the traveling direction of subject vehicle V.

As described above, according to the present embodiment, a road surface captured by the imaging apparatus is divided into cells, and a distance to a representative point of each cell is derived by the TOF method. Furthermore, a road surface grade is estimated based on derived distances to representative points of a plurality of cells.

Consequently, it is possible to precisely estimate a road surface grade.

Furthermore, according to the present embodiment, information of each pixel included in each cell is used to derive a distance to the representative point of each cell, so that distance measurement precision improves. Consequently, it is possible to precisely estimate a road surface grade.

(Modified Example 1)

In addition, in the above embodiment, cells are divided such that cell shapes in the zenith view are square shapes. However, the cell division is not limited to this.

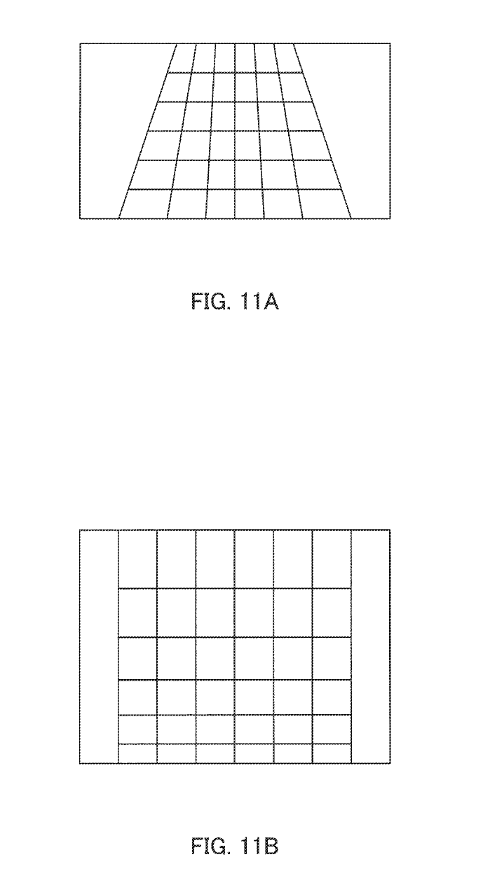

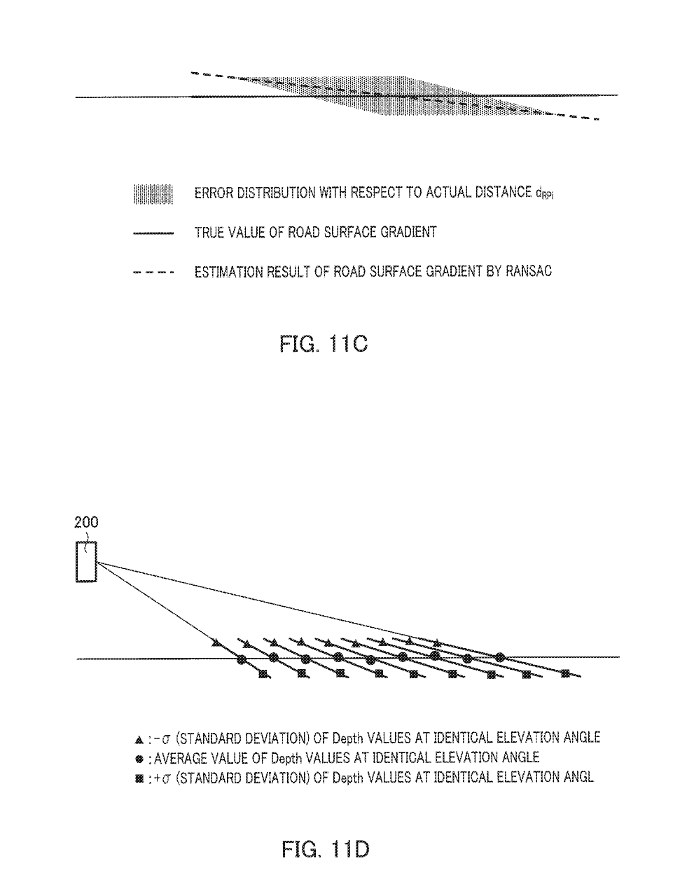

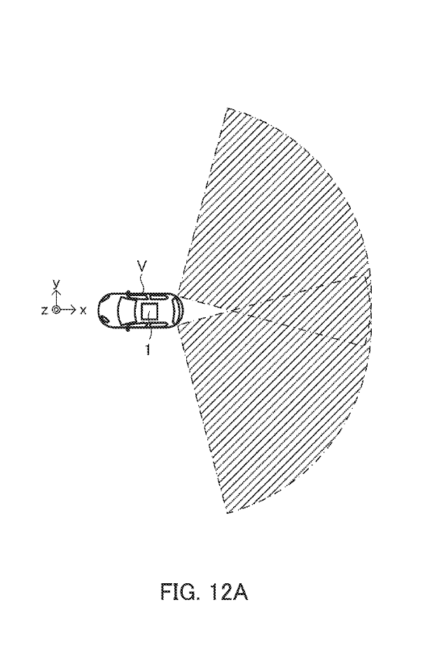

Distance measurement precision of the TOF method lowers as a distance from subject vehicle V to a target (a road surface in this case) which is an object becomes farther. On the other hand, when information of each pixel included in each cell is used to calculate a distance to a representative point of each cell, as the number of pixels included in each cell is larger, distance measurement precision improves more. Hence, the size of each cell may be made the same in a captured image or, when a distance from subject vehicle V is farther in the zenith view, cells may be made larger (see FIGS. 11A and 11B).

Furthermore, in the above embodiment, the representative point is set to the center point of each cell. However, the representative point setting is not limited to this. The representative point may be set to any pixel in each cell. In this case, information of each pixel included in each cell may be weighted to derive a distance to the representative point.

(Modified Example 2)

In the above embodiment, distances to representative points of two neighboring cells in the traveling direction of subject vehicle V are used to estimate a road surface grade. However, the road grade estimation is not limited to this. Data of representative points of three or more continuous cells may be used, or data of representative points of a plurality of non-continuous cells may be used.

Furthermore, for example, reference distance D_{RPi} and actual distance d_{RPi} to the representative point of each cell may be calculated, and then these results may be used to estimate a road surface grade by using a random sample consensus (RANSAC) algorithm. By using the RANSAC algorithm, it is possible to expect improvement of grade estimation precision. By using reference distance D_{RPi} and actual distance d_{RPi} to the representative point of each cell, it is also possible to expect improvement of control precision which uses the RANSAC algorithm and reduction of a computation time.

In addition, an error distribution with respect to actual distance d_{RPi} is a substantially parallelogram as shown in FIG. 11C. Therefore, if the RANSAC is applied, a straight line which connects diagonal lines of the substantially parallelogram is likely to be outputted as an estimation result of the road surface grade. In this case, by, for example, calculating an approximate value of the straight line which connects an average value of actual distance d_{RPi} of each cell by RANSAC or a least-squares method, it is possible to precisely estimate the road surface grade.

In addition, by averaging an estimation value calculated by using the average value, an estimation value calculated by using +σ (standard deviation) of actual distance d_{RPi}, and an estimation value calculated by using −σ (standard deviation) of actual distance d_{RPi}, it is naturally possible to more precisely estimate the road surface grade (see FIG. 11D), In addition, instead of +σ and −σ, +2σ and +3σ may be used. Furthermore, the average value is used for description. However, a median may be used. Furthermore, instead of using RANSAC, average values may be simply connected.

(Modified Example 3)

When there is a target on a road surface, a road surface grade may be estimated, and then the height of the target on the road surface may be further estimated. In this case, by subtracting the height of the road surface at a position at which there is the target from a value obtained by calculating the height from the reference road surface to an upper end of the target, the height of the target may be estimated.

(Modified Example 4)

In the above embodiment, the height of a representative point of each cell is calculated to estimate a road surface grade. However, the road surface estimation is not limited to this. For example, a coordinate of the representative point of each cell may be calculated to estimate the road surface grade. Furthermore, the calculated height and coordinate of the representative point of each cell may be used for another control.

(Modified Example 5)

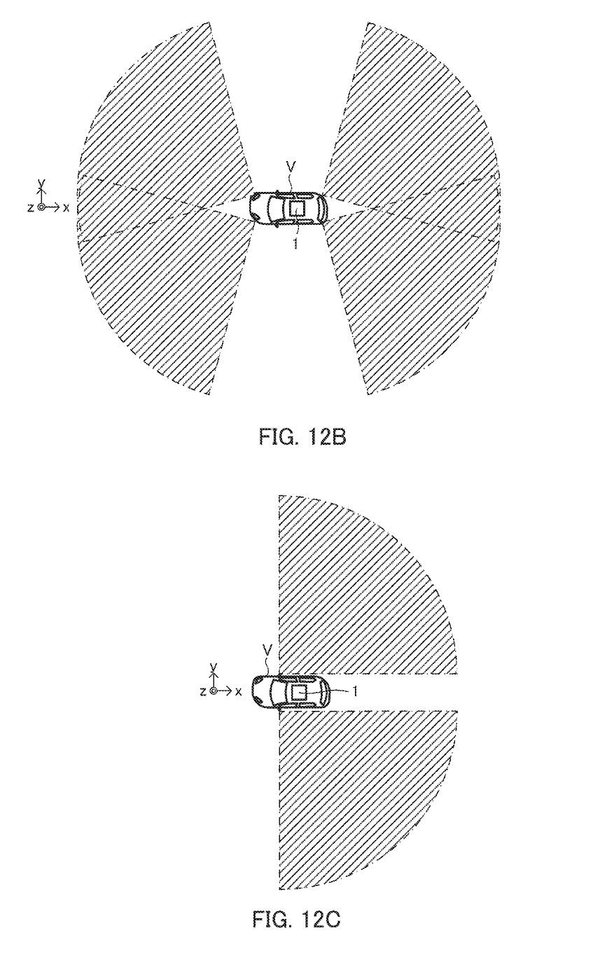

The above embodiment has described a case where imaging apparatus 200 is attached to a back surface of the vehicle. However, imaging apparatus 200 is not limited to this. Even when an imaging apparatus installed for use in monitoring surroundings of the vehicle is used as shown in FIGS. 12A to 12C, it is possible to precisely estimate the gradient of the road surface similar to the above embodiment.

(Modified Example 6)

In the above embodiment, when each cell includes a target other than a road surface, each cell is excluded from a processing target of distance measurement processing.

However, the processing target exclusion is not limited to this. For example, a pixel corresponding to the target in each cell may be excluded from a computation target for deriving a distance to the representative point.

(Modified Example 7)

The above embodiment has described the example where distances to all representative points are derived by using information of each pixel included in each cell. However, deriving of distances is not limited to this. For example, only distances to representative points of cells whose distances are apart from a vehicle by a predetermined value may be derived by using information of each pixel included in each cell.

While various embodiments have been described herein above, it is to be appreciated that various changes in form and detail may be made without departing from the spirit and scope of the invention(s) presently or hereafter claimed.

This application is entitled and claims the benefit of Japanese Patent Application No. 2017-206031, filed on Oct. 25, 2017, the disclosure of which including the specification, drawings and abstract is incorporated herein by reference in its entirety.

### INDUSTRIAL APPLICABILITY

The road surface detection apparatus, the road surface detection method and the recording medium having the road surface detection program recorded thereon according to the present disclosure can precisely estimate a road surface grade, and are suitable for use in vehicles.

### REFERENCE SIGNS LIST

1 Surrounding monitoring system
100 Road surface detection apparatus
110 Imaging controller
120 Distance measurer
130 Road grade surface estimator
140 Storage section
200 Imaging apparatus
210 Light source
220 image sensor
301, 302 Roadway edge marking
303 Road surface

1. A road surface detection apparatus, comprising:
an inputter that receives an input of an image signal from an imaging apparatus;
a distance measurer that divides a road surface region into a plurality of cells based on the image signal, and derives a distance to a representative point of each of the cells by a time of flight distance measurement method; and
an estimator that estimates a gradient of the road surface based on the distances to a plurality of the representative points.

2. The road surface detection apparatus according to claim 1, wherein the estimator estimates the gradient of the road surface based on a reference distance to the representative point stored in advance, and the distance to the representative point derived by the distance measurer.

3. The road surface detection apparatus according to claim 2, wherein the reference distance is the distance to the representative point in a case where the road surface is assumed to be flat.

4. The road surface detection apparatus according to claim 1, wherein the distance measurer derives the distance to the representative point by excluding a target other than the road surface.

5. The road surface detection apparatus according to claim 4, wherein
the image signal is an infrared image signal, and
the distance measurer distinguishes the road surface based on a brightness of the infrared image signal.

6. The road surface detection apparatus according to claim 5, wherein, when each of the cells includes a predetermined rate or more of a portion in which brightness is higher than a predetermined value, the distance measurer decides that each of the cells includes the target other than the road surface.

7. The road surface detection apparatus according to claim 1, wherein the distance measurer derives a distance to the road surface corresponding to each pixel in each of the cells by the time of flight distance measurement method, adds and averages the derived distance to the road surface corresponding to each pixel, and calculates the distance to the representative point.

8. The road surface detection apparatus according to claim 1, wherein the distance measurer integrates a return light component of each pixel in each of the cells, and derives the distance to the representative point by the time of flight distance measurement method based on an integration value of the return light component.

9. The road surface detection apparatus according to claim 1, wherein the distance measurer distinguishes a roadway edge marking based on the image signal, and extracts a region surrounded by the roadway edge marking as the road surface region.

10. The road surface detection apparatus according to claim 1, wherein the distance measurer sets a center point of each of the cells to the representative point.

11. The road surface detection apparatus according to claim 2, wherein the estimator estimates the gradient of the road surface by using an RANSAC algorithm.

12. The road surface detection apparatus according to claim 2, wherein the estimator estimates the gradient of the road surface by using an average value of the distance to the representative point of each of the cells derived by the distance measurer.

13. The road surface detection apparatus according to claim 12, wherein the estimator further estimates the gradient of the road surface by using a standard deviation of the distance to the representative point of each of the cells derived by the distance measurer.

14. The road surface detection apparatus according to claim 1, wherein the estimator estimates the gradient of the road surface, and then further estimates a height of a target on the road surface.

15. The road surface detection apparatus according to claim 1, wherein the estimator estimates the gradient of the road surface based on a height of the representative point.

16. The road surface detection apparatus according to claim 1, wherein the estimator estimates the gradient of the road surface based on a coordinate of the representative point.

17. The road surface detection apparatus according to claim 1, wherein all of sizes of the cells are equal to each other.

18. A road surface detection method, comprising:
receiving an input of an image signal from an imaging apparatus;
dividing a road surface region into a plurality of cells based on the image signal, and deriving a distance to a representative point of each of the cells by a time of flight distance measurement method; and
estimating a gradient of the road surface based on the distances to a plurality of the representative points.

19. A recording medium including a road surface detection program recorded therein, the road surface detection program causing a computer to execute processing comprising:
receiving an input of an image signal from an imaging apparatus;
dividing a road surface region into a plurality of cells based on the image signal, and deriving a distance to a representative point of each of the cells by a time of flight distance measurement method; and
estimating a gradient of the road surface based on the distances to a plurality of the representative points.
